(19) United States
(12) Patent Application Publication
(10) Pub. No.: US 2012/0109954 A1
(43) Pub. Date: May 3, 2012

(54) UBIQUITOUS BOOKMARKING

(75) Inventor: Scott WHITE, Austin, TX (US)

(73) Assignee: AT&T INTELLECTUAL PROPERTY I, L.P., Reno, NV (US)

(21) Appl. No.: 12/912,923

(22) Filed: Oct. 27, 2010

(51) Int. Cl. G06F 17/30

(52) U.S. Cl. 707/737; 707/741; 707/E17.037; 707/E17.089

(57) ABSTRACT

Data for items of information are marked, stored and retrieved. A method for marking, storing and retrieving data for items of information. Markable data is received at an electronic device. The received markable data is marked using an input of the electronic device dedicated to selectively marking received markable data at the discretion of a user of the electronic device. The received marked data is stored as marked data in response to marking the received information. The stored marked data is retrieved using the electronic device. The stored marked data is obtained and presented.

### BACKGROUND

1. Field of the Disclosure

The present disclosure relates to information management. More particularly, the present disclosure relates to electronically marking items of information in a manner in which the electronic marks for the items of information can be later retrieved.

2. Background Information

Individuals encounter vast amounts of information in their daily lives. Such information may be video and/or audio broadcasts of content or advertisements. Such information may also be content or advertisements provided online or by newspapers or magazines or other mediums. Common mechanisms for noting items of information of interest to an individual include written notes and photographs.

Proposals have been made for television systems by which individuals using remote controls can mark interest in items of information in a television broadcast. In one proposed system, a data stream choreographed with a television broadcast contains data for items of information in the broadcast. The data stream is sent by radio network directly to a specialized remote control rather than the television. An individual viewer can perform an action such as purchasing an item of information in the broadcast by selecting data from the data stream at the press of a button on the specialized remote control. The specialized remote control is linked to the radio network, and the selection is sent to a service over the radio network. In another such proposed system, data for items of information in a television broadcast is provided in the television broadcast. An individual viewer can mark the data in the broadcast at the press of a button on a specialized remote control. The specialized remote control is linked to the internet, and the mark is sent to a service over the internet so that the individual can retrieve and act upon the mark later over the internet.

### BRIEF DESCRIPTION OF THE DRAWINGS

FIG. 1 shows an exemplary general computer system that includes a set of instructions for ubiquitous bookmarking described herein;

FIG. 2 shows an exemplary ubiquitous bookmarking communications device, according to an aspect of the present disclosure;

FIG. 3 shows an exemplary ubiquitous bookmarking network, according to an aspect of the present disclosure;

FIG. 4 shows an exemplary ubiquitous bookmarking process, according to an aspect of the present disclosure;

FIG. 5 shows another exemplary ubiquitous bookmarking process, according to an aspect of the present disclosure; and

FIG. 6 shows another exemplary ubiquitous bookmarking network, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

The present application describes mechanisms to enable individuals to register interest in items of information they encounter in their daily lives. Items of information as described herein are to be construed broadly to include anything perceptible to a human such as webpages, books, articles, shows, movies, advertisements, clothes, artwork, songs, specific articles shown in webpages or shows or movies or advertisements, or anything else perceptible to a human. Items of information are not limited to electronic information. Markable data for an item of information as described herein is data that corresponds to an item of information, and that can be used later to retrieve/recall the item of information. As an example, markable data may include an identification number and/or description of an item of information.

Registration of interest in items of information as described herein is called marking or bookmarking. The present application may therefore interchangeably refer to registering interest as marking or bookmarking.

The present application describes marking items of information. However, marking as described herein is actually performed by selectively recording markable data for items of information, and not necessarily by recording the entirety of items of information. Marking is performed by selectively recording data using a device that initially receives or captures the data. Marking is performed in a manner such that the selectively recorded data can be subsequently retrieved and correlated to the item of information. The data is selectively recorded using the device when an individual is presented with the data by the device and selects the data using an input interface on the device.

The device used to bookmark data for an item of information may be a mobile personal device, such as a cell phone or camera or laptop or notebook computer. The device used to bookmark data for an item of information may also be a device relatively fixed in location, such as a radio or television or personal computer.

An initial example of ubiquitous bookmarking uses a specialized device made available by a museum for visitors. The museum associates each of a set of particular displays with wireless transmitters that each transmit a unique identification and a description for the associated display. Alternatively, the museum associates a group of multiple displays with a single wireless transmitter that transmits a unique identification and a description for each display of the group. In either instance, the user of the specialized device can mark an individual display as the device comes within range of the transmitter for the display, or the user of the device can selectively mark an individual display among a group of multiple displays as the device comes within range of the transmitter for the group of displays.

In this example, the visitor with the device can register interest in a particular display by providing input to an input interface on the specialized device when the identification and description for the particular display is shown on an output interface of the specialized device. The user can then retrieve the registrations later in order to visit a website and obtain background information on the displays registered during the visit to the museum. The example of a museum can be substituted with a store that transmits identifications for sale items, an outdoor historical park that transmits identifications of monuments, or any other site that would benefit from enabling visitors to selectively register interest in items of information among numerous items of information.

For any embodiment described herein, bookmarks aggregated by one or more of a user's devices can be provided to and coordinated by a software program on a user device such as a personal computer. Alternatively, bookmarks aggregated by one or more of a user's devices can be provided to and coordinated by an internet service.

The software program or internet service can develop a list of bookmarked items of information. The software program or internet service can generate background information for bookmarked items of information, and provide such background information to the user. The software program or internet service may also provide the user with an ability to manipulate, refine and organize bookmarks.

The mechanisms for marking data described herein include hardware devices and/or software programs, used alone or in combination, to selectively record data corresponding to an item of information. The hardware devices include input interfaces and output interfaces. Output interfaces alert the user to the receipt and presence of markable data for items of information. Input interfaces enable the user to selectively record the markable data for items of information. Software programs, when executed by processors of the devices, selectively record the markable data for an item of information.

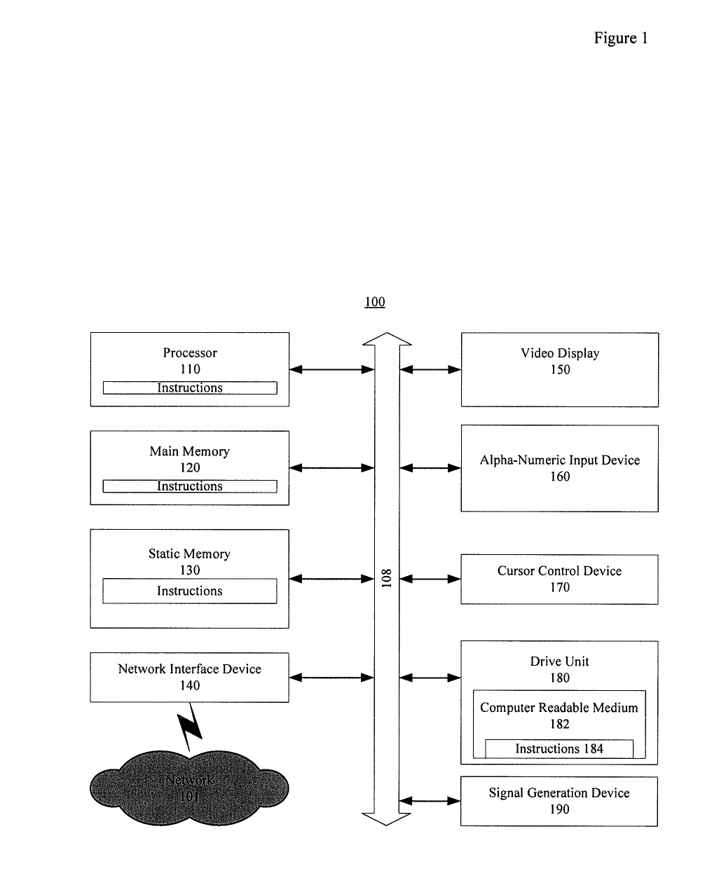

FIG. 1 is an illustrative embodiment of a general computer system that includes a set of instructions for performing ubiquitous bookmarking processes as described herein. The general computer system is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices. For example, the computer system 100 may include or be included within any one or more of the computers, servers, systems, or communication networks described herein.

In a networked deployment, the computer system may operate in the capacity of a server or as a client user computer in a server-client user network environment, or as a peer computer system in a peer-to-peer (or distributed) network environment. The computer system 100, or portions thereof, can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an alpha-numeric input device 160, such as a keyboard, another input device (not shown), such as a remote control device having a wireless keypad, a keyboard, a microphone coupled to a speech recognition engine, a camera such as a video camera or still camera, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to the present disclosure, individuals bookmark items of information by recording data corresponding to the items of information on a device. The recorded data is retrieved later so that the individual can recall the items of information. The recorded data is correlated to the items of information, and can be used by a user's software program or internet service to retrieve background information descriptive of the items of information. The software program or internet service can also organize the items of information.

Using a device, different items of information can be marked at different times and in different locations. For example, a device such as a smartphone may include a bookmarking software program that enables the smartphone to recognize available markable data for items of information within range of the smartphone. Fixed data for the items of information is repeatedly transmitted by local wireless transmitters. The fixed data transmitted by a transmitter includes identifications and descriptions of one or more items of information, and the fixed data is received by network interface device 140 of the smartphone when within range of the transmitter. The user of the device may view the available data for items of information on video display 150. The bookmarking software program may configure an alpha-numeric input device 160 of the smartphone to accept input from the user to selectively mark markable data, and the selected data is stored in main memory 120.

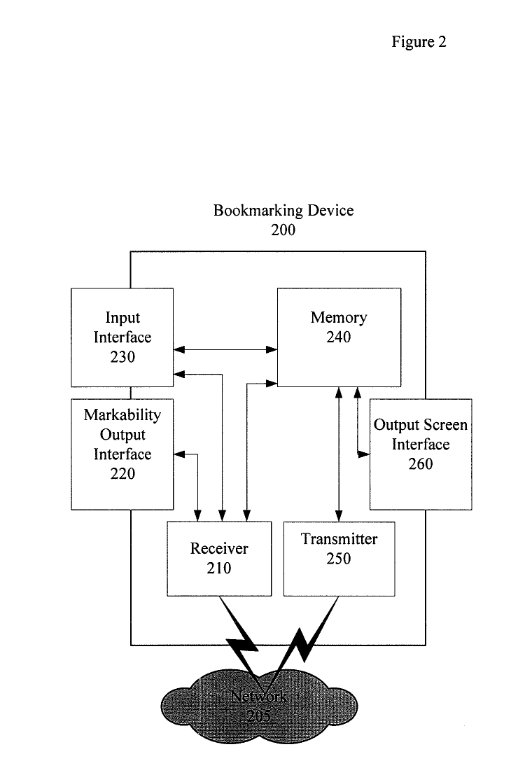

FIG. 2 shows an exemplary ubiquitous bookmarking communications device 200, according to an aspect of the present disclosure. Examples of a bookmarking device 200 in FIG. 2 include a networked television, remote control device, mobile phone of any type, radio including car radio, computer of any type, camera, or specialized bookmarking device with functionality dedicated to bookmarking as described herein.

In FIG. 2, a bookmarking device 200 includes a receiver 210 and a transmitter 250 for communicating over a network 205. The bookmarking device 200 also includes a memory 240 and at least one processor (not shown). A markability output interface 220 outputs an indication that data received by the receiver 210 is markable data corresponding to an item of information. An output screen interface 260 is an output screen to display text such as a description of the item of information so as to advise the user of the identity of the item of information corresponding to the markable data. When the data received by the receiver 210 is markable, the individual can activate an input interface 230 to record the data for the item of information in the memory 240. The input interface 230 instructs the memory 240 to record the data for the item of information, and the memory 240 records the data for the item of information in response to the instruction from the input interface 230.

An input interface 230 herein may include any known form of input interface for computing, entertainment or communications devices. The input interface 230 may be a bookmark button provided on a cell phone, car stereo, home audio/visual equipment, computer monitor or keyboard or any other device of this nature. An input interface 230 may include hardware components dedicated to the sole-function/single-use of selectively marking data for items of information. A dedicated hardware input interface 230 is an interface permanently dedicated to accepting markings of data for items of information. An input interface 230 may also include hardware components with configurable functions that vary in accordance with a current state of the bookmarking device.

An input interface 230 may also or alternatively include software components dedicated to the sole-function/single-use of selectively marking data for items of information. A dedicated software input interface 230 is an interface permanently dedicated to accepting markings of data for items of information. An input interface 230 may also include software components with configurable functions that vary in accordance with a current state of the bookmarking device.

Examples of an input interface 230 include tangible buttons, knobs, switches, portions of tangible touch-screens, computer mouses or other cursor-control device. Such input interfaces 230 may also include graphical or other virtual inputs such as entry windows or virtual buttons on a graphical user interface. Either tangible or virtual input interfaces 230 may be dedicated or configurable as set forth above. Examples of a configurable hardware input interface 230 include a switch that selects data only when a knob on the device 200 is set to a particular position. Examples of a configurable software input interface 230 include a virtual entry window or menu button on a graphic user interface that is only presented when the user navigates to a website that includes the virtual entry window or menu button.

A markability output interface 220 and/or an output screen interface 260 may include a graphical user interface that alerts the individual to the presence of markable data for items of information. The markability output interface 220 may be as simple as a light emitting diode that illuminates when data received by the receiver 210 is recognized by a software program as markable data corresponding to an item of information. As an example, a radio receiver device 200 may include such a light emitting diode 220 that lights up for particular songs or commercials playing on particular stations. Alternatively, a television receiver device or associated remote control 200 may include a light emitting diode 220 that lights up for a program, commercial or even an individual element of a program or commercial currently playing on the television. In the example of a modified radio or television receiver, the item of information for which recordable data is present may be obvious to the individual, such as when the items of information is the song or commercials currently playing on a radio, or program, commercial or individual highlighted element of a program or commercial currently playing on a television. When the light emitting diode 220 illuminates, an individual in the presence of the radio or television can be made aware that interest in the item of information currently being presented (e.g., song or sale item in a commercial) may be selectively registered. The output screen interface 260 when present may be as simple as a small screen that displays text information of data or an icon for an item of information.

As an example of a ubiquitous bookmarking application, the bookmarking device 200 may be a smartphone that stores and executes a software program to recognize markable data for items of information. The software program can be a program that dynamically processes data captured or received by the smartphone, such as audio captured by microphone, image data captured by a camera, or metadata received by the receiver 210. Another software program on the smartphone allows individuals to bookmark such markable data once recognize. Such a smartphone can send markable data for the items of information to a service that coordinates bookmarks for a user and retrieves background information when applicable. The user can then visit a website for the service and log in to review bookmarks and obtain background information. The smartphone may use a software program downloaded by a user to coordinate the ability to mark data and send the marked data to the service.

As an example of the markable data that can be recognized by a smartphone 200 in the example above, advertisers may associate markable data with a billboard advertizing an item for sale, or with a retail outlet location. Wireless transmitters repeatedly transmit the markable data along with identifications and descriptions for the associated sale item or retail outlet location. The user can then retrieve the recorded data later in order to visit a website and obtain background information on the selected sale item or retail outlet location.

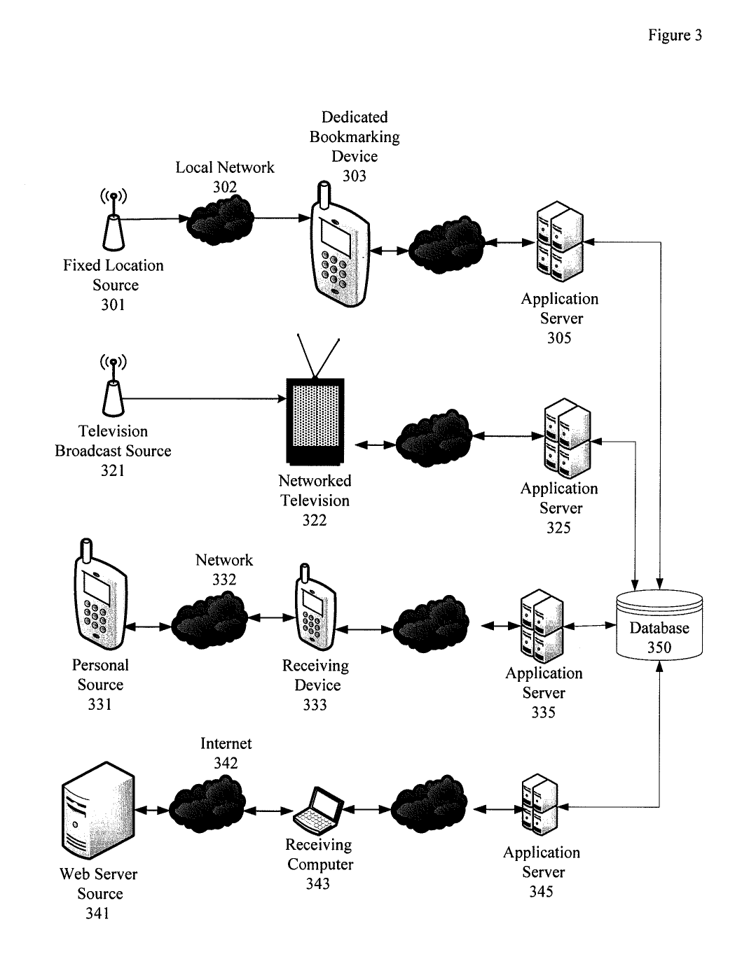

FIG. 3 shows an exemplary ubiquitous bookmarking network, according to an aspect of the present disclosure. FIG. 3 shows a variety of sources for recordable data corresponding to items of information. Sources in the exemplary network of FIG. 3 include fixed location source 301, television broadcast source 321, personal source 331, and web server source 341.

Fixed location source 301 is a source such as that described herein with respect to the museum example. A fixed location source 301 may repeatedly and periodically transmit markable data for a nearby item of information in accordance with a 802.11x communications standard. One or more fixed location sources 301 can provide recordable data for one or more items of information in close proximity to the fixed location sources 301. Individuals can thereby receive the recordable data on a dedicated bookmarking device 303 directly or over a local network 302.

Television broadcast source 321 is a source such as that described herein with respect to television and radio examples. One or more television broadcast sources 321 can provide recordable data for one or more items of information in programs or commercials on television channels. Individuals can thereby receive the recordable data on a networked television 322.

Personal source 331 is a source such as a smartphone or personal computer. One or more personal sources 331 can provide recordable data for items of information generated by, stored on, or otherwise corresponding to the personal sources 331. Individuals can thereby receive the recordable data on a receiving device 333 over network 332.

Web server source 341 is a source for content provided by internet websites. One or more web servers sources 341 can provide recordable data for items of information provided on or via websites hosted by the web server sources 341. Individuals can thereby receive the recordable data on a receiver computer 343 via internet network 342.

Each of the dedicated bookmarking device 303, networked television 322, receiving device 333 and receiving computer 343 is shown communicating with respective application servers 305, 325, 335 and 345. The application servers 305, 325, 335 and 345 in turn communicate with database 350. The application servers 305, 325, 335 and 345 coordinate bookmarks and provide background information for bookmarked items of information. The application servers 305, 325, 335 and 345 store user information, including bookmarks and background information, in database 350. Users who bookmark items of information using devices 303, 322, 333 or 343 can retrieve the bookmarks and background information from database 350 using the same devices 303, 322, 333 or 343 or other devices capable of communicating with database 350.

In the embodiment of FIG. 3, the various types of bookmarking devices 303, 322, 333, 343 can be used by a single user. Bookmarks for all receiving devices 303, 322, 333, 343 can be coordinated by a software application on the receiving device 333 or receiving computer 343, or by an internet service that provides the application servers 305, 325, 335, 345. The devices 303, 322, 333, 343 may also all communicate with a single one of the single application servers 305, 325, 335, 345 when properly configured. Additionally, the source and receiver devices herein are merely exemplary, and bookmarking devices may include any apparatus with a positively configured ability to transmit and/or receive and process and store markable data. Therefore, users may ubiquitously bookmark data using different user devices throughout the day as they experience all manners of information, and the bookmarked data can be coordinated for presentation on one of the receiving device 333 and/or receiving computer 343. Such markable items of information may be present in the user's daily life in many different forms and formats, and can be selectively registered by the user at the press of a button on one or many of the user's devices. The markable data may be present in signal data, audio or video content, images, or any other electronic form of data that can be interpreted and processed by a bookmarking device.

An example of a dedicated bookmarking device 303 in FIG. 3 may be a single-function keyfob with a simple input interface 230, such as a pushbutton, and a simple markability output interface 220 such as a light emitting diode. In such cases, the output interface 220 may not be capable of providing individuals with any level of detail of marked data for items of information, and instead will only be capable of providing individuals with a basic warning that markable data for an item of information is present. In the example of a keyfob as dedicated bookmarking device 303, the items of information may be individual items in a museum or similar environment, and the keyfob may be a specialized device that individuals can use to bookmark particular displays. In this way, a museum could sell or rent the keyfobs to visitors and then provide a website to allow visitors assigned the keyfob to obtain background information about bookmarked displays.

An example of the networked television 322 in FIG. 3 is a modification of a known networked television to include a markability output interface 220 and bookmarking input interface 230. The input interface 230 is coupled with a markability output interface 220 to notify a user of the networked television 322 when markable data for an item of information in a program is available for selection. Of course, the markability output interface 220 and bookmarking input interface 230 may be provided on a remote controller of the networked television 322, rather than on the networked television itself. The markability output interface 220 can be as simple as a light emitting diode that illuminates on the networked television 322 or a remote control, or as complicated as a graphical user interface that provides text or other graphical output on the networked television 322 or remote control. The input interface 230 can be as simple as a button on the networked television 322 or a remote control for the networked television 322, or as complicated as a touch screen on the networked television 322 or remote control that presents text and graphical output for selection. The markability output interface 220 notifies the user when data for the content currently playing on the networked television 322 is available for bookmarking. This way, a user can register interest in content such as a commercial or show on the networked television 322. Content providers provide metadata as the markability data either with or as part of the content so that the user can later identify and obtain background information for the bookmarked content.

The networked television 322 in FIG. 3 is also analogous to a networked radio or other broadcast receiver. Such a networked radio or other broadcast receiver could similarly be modified to include a bookmarking input interface 230 and markability output interface 220, as well as a capacity to receive, process and store markable data. Similarly, the uses of an internet service or user computer program on a receiving computer 343 can similarly be provided so long as the networked radio or other broadcast receiver is modified to include internet or local communication capabilities.

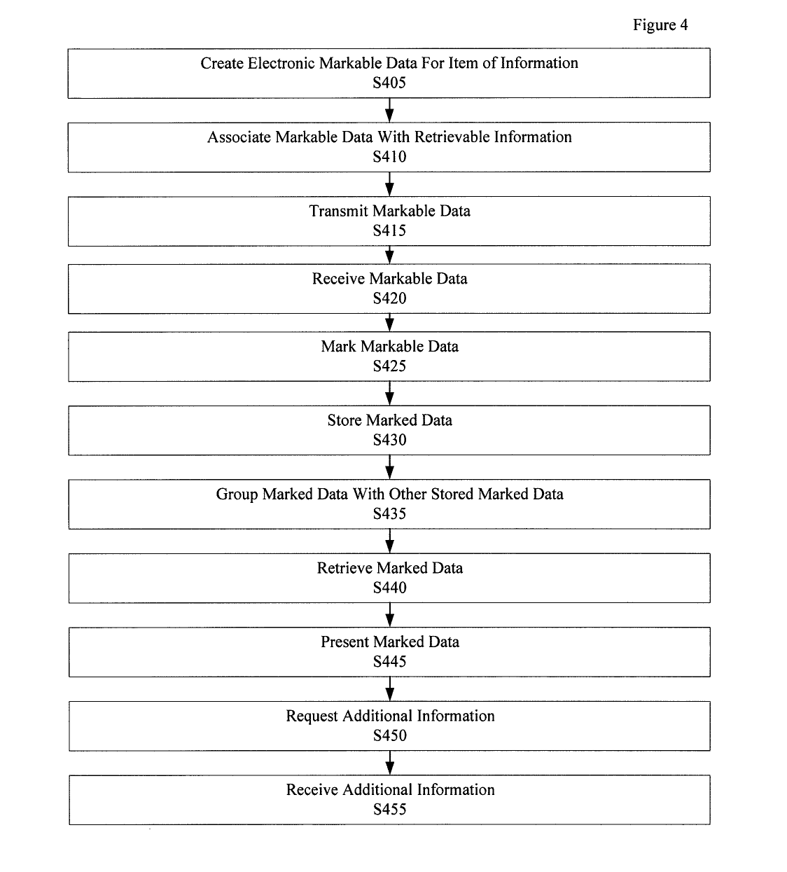

FIG. 4 shows an exemplary ubiquitous bookmarking process, according to an aspect of the present disclosure. At s405, electronic markable data is created for an item of information by, e.g., a party responsible for the item of information. At s410, the markable data is associated with retrievable information. At s415, the markable data is transmitted. At s420, the markable data is received by a user with a device capable of marking data for items of information. At s425, the markable data is marked using the device. At s430, the marked data is stored. At s435, the marked data is grouped with other stored marked data. At s440, the marked data is retrieved. At s445, the marked data is presented to the user. At s450, additional information is presented to the requester. At s455, additional information is requested.

In the process of FIG. 4, the markable data for an item of information is associated with retrievable information at s410. This retrievable information is background information of the sort obtained and provided by a software application or web service as described herein. Details of the items of information beyond the bookmarks may also be later provided to the individual based on the bookmarking by the individual.

In the process of FIG. 4, markable data at s415 may be transmitted either at the specific instruction of a user of, e.g., a personal source 331, or along with other scheduled content such as music or broadcast programming from a television broadcast source 321, or periodically such as from a fixed location source 301 in the museum example described herein. Devices capable of marking data for items of information receive the markable data at s420, and the markable data is marked at the instruction of users of the devices at s425.

On the back end, background information can be provided to users via a website. The marked data for items of information may include an identification that can be correlated with the item of information and, in turn, to background information stored in database 350 by the provider of the markable data for items of information. Alternatively, the background information for an item of information can be provided by third party services or programs other than the provider of the markable data for items of information. Thus, a user of a marking device such as dedicated bookmarking device 303 in FIG. 3 can mark data for an item of information for later retrieval and also obtain background information for the item of information.

As another example, an advertiser may want to provide background information about an item of information advertised for sale. The background information may include a manufacturer or designer, a price, or an address of a sales outlet. The marked data may include an embedded website address, so that when the individual later retrieves the marked data the individual can visit the website to obtain the background information. The markable data may also be pre-linked with descriptions or offer information as background information by a provider of the items of information and markable data. A program can automatically use retrieved marks to obtain such data from the providers over the internet, or offer to do so on a case-by-case basis for the user.

As described above, an individual may desire further information of any sort when presented with markable data for an item of information encountered in daily life. Using a device as described herein, an individual can mark the markable data, such as when the individual is not able to interrupt what they are doing and obtain and consume background information about a particular item of information. For example, an individual may drive past a billboard displaying an interesting item of information, but may not be able to immediately seek out additional info about the item of information on the billboard. Similarly, an individual may hear a song by a new artist on the radio, but will need to wait until later before they can learn more about the artist via the Internet. In these examples, a device as described herein may be used to bookmark the markable data for the item of information selected by the individual. Background information for the bookmarked items of information can then be provided to the individual. In the example of bookmarking data for a song on the radio from a radio station, an internet service may provide background information to the individual including:

song name and lyrics

information about the artist

upcoming concert dates and locations for the artist

a source for concert tickets for upcoming concerts

a source and cost for the bookmarked song

sales items related to the artist or song

As another example of context for ubiquitous bookmarking, a device with a specialized software program with bookmark recognition ability can dynamically interpret captured information such as audio or visual information captured by a device microphone or camera, or metadata received by a device wireless receiver. The specialized software program can automatically analyze captured or received audio or visual information or metadata to search for markable data. The markable data may be recognizable as such due to a particular arrangement of the data that the specialized software program recognizes. For example, audio or video content may include data in a particular format that is recognized as a format for markable data. The identity of the particular associated item of information could then be determined from the markable data by the specialized software program. In this example, the user is notified by an output interface on the device when the software program dynamically recognizes markable data for an item of information such as a song playing in a nightclub or a photograph taken in a public location. The user may also be notified of the particular identity of the item of information when an output interface of the user's device has the capability to provide text, icon or audible details to the user.

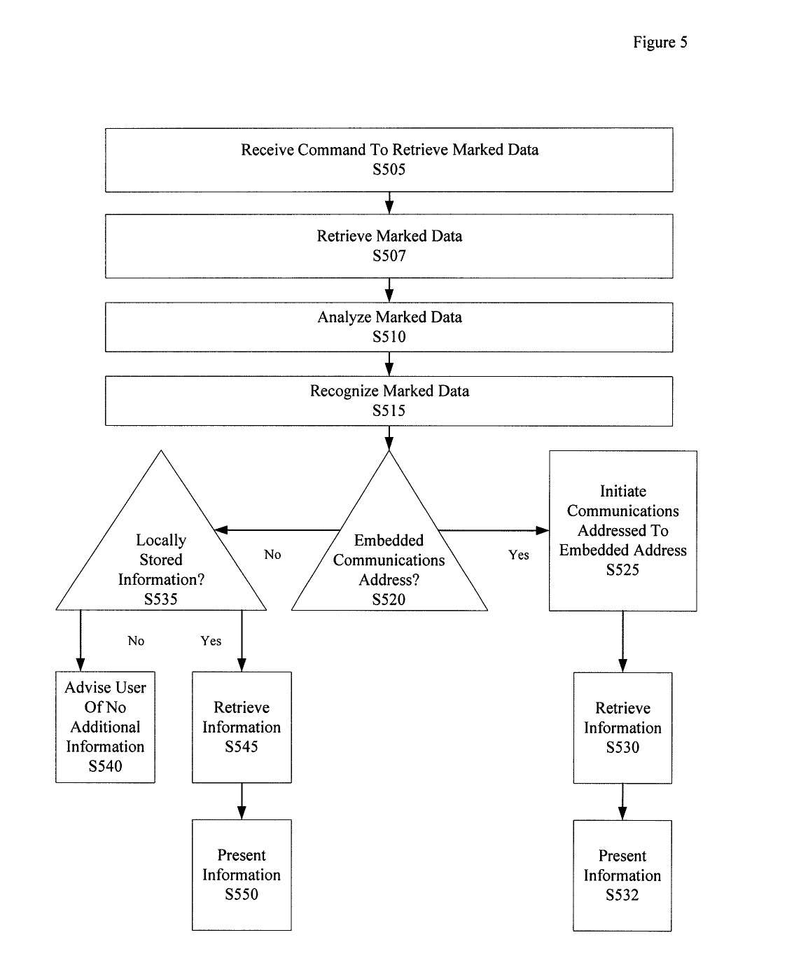

FIG. 5 shows another exemplary ubiquitous bookmarking process, according to an aspect of the present disclosure. The process of FIG. 5 shows a manner in which stored electronic data (bookmarks) can be retrieved and used to obtain background information for the bookmarked item of information. The background information is obtained either using an interne service or a software application on the bookmarking device.

At s505, a command to retrieve marked data is received. At s507, the marked data is retrieved. At s510, the marked data is analyzed. At s515, the marked data is recognized as a result of the analysis at s510. At s520, a determination is made as to whether the marked data contains an embedded communications address. If the marked data contains an embedded address, communications addressed to the embedded address are initiated at s525. Background information is thereafter retrieved from the embedded address at s530, and this information is presented to the user at s532. If the marked data does not contain an embedded address, a determination is made whether background information is stored locally. If no background information is stored locally, the user is advised at s540 that there is no additional information for a bookmarked item of information. However, if background information is stored locally, the background information is retrieved at s545 and presented at s550.

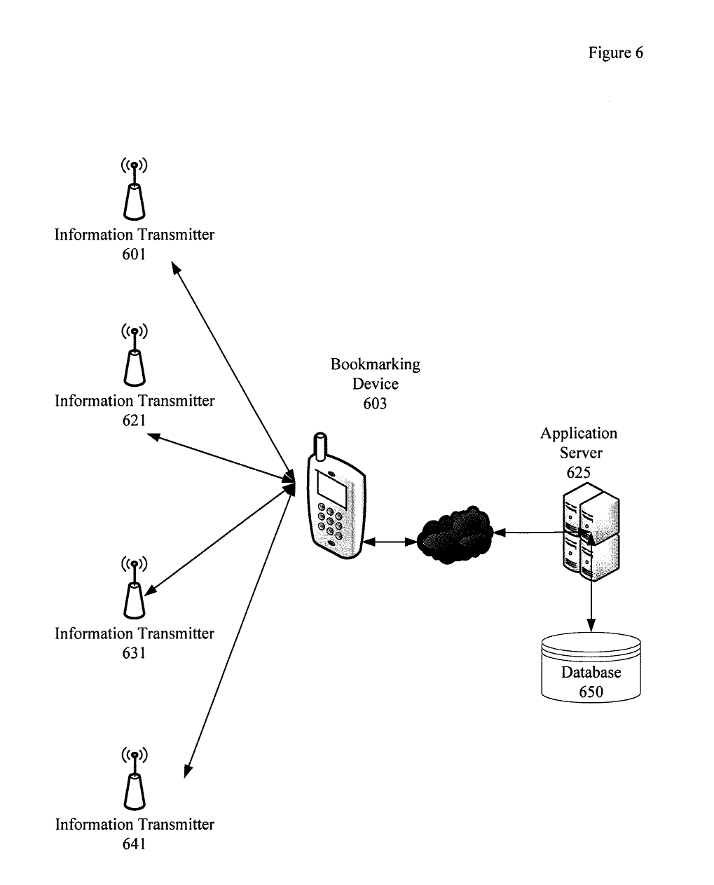

FIG. 6 shows another exemplary ubiquitous network, according to an aspect of the present disclosure. In FIG. 6, multiple information transmitters 601, 621, 631 and 641 transmit information to bookmarking device 603. FIG. 6 shows a network applicable to the museum example described herein. That is, information transmitters 601, 621, 631 and 641 can be placed in different locations, and provide recordable data for nearby items of information.

The bookmarking device 603 provides the bookmarked data to application server 625 through a network. The bookmarked data is correlated with background information in database 650, and a user or subscriber can retrieve the bookmarks and background information from database 650 using bookmarking device 603 or another device.

As set forth above, user devices may be provided with the ability to bookmark electronic data for items of information encountered by users throughout the day in different locations. The user devices may be dedicated bookmarking devices, or may be modifications of known devices to include input interfaces and output interfaces for presenting and selecting bookmarkable data in the presence of corresponding items of information. The bookmarkable data may be provided by a source of the item of information, or may be generated on the user device using a program that determines the identity of an item of information such as a song playing in a nightclub or landmark or person in a photograph. In the example of photographs or other dynamically-captured items of information, interpretive logic on a user device might recognize bookmarkable data that is invisible to the user's eye.

An example of an interpretive software program is one that is location specific, such as a program that a user can download location-specific markable data prior to visiting a city or particular site. Such an interpretive software program can include processes and data that automatically interpret and recognize markable data for the user when the user visits the city or particular site.

As also described above, a user's software program or online service can aggregate bookmarks. The program or service can organize bookmarks into lists, obtain and provide background information for items of information to users, or providing users an opportunity to purchase things related to the bookmarked items of information. Thus, users can bookmark items of information throughout the day using different user devices, and organize and obtain background information for items of information later using a software program or internet service. The marked data from different user devices may be coordinated through a local area network by software on a user computer, or may be coordinated through the internet by a service.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims. For example, although the description herein references particular examples and embodiments of items of information for which markable data can be provided, such markable data can be provided for virtually any item of information that could be isolated and recognized by an individual wishing to make note of the item of information.

As described above, data for items of information is marked, stored and retrieved, according to an aspect of the present application. Markable data is received at an electronic device. The received markable data is marked using an input of the electronic device dedicated to selectively marking received markable data at the discretion of a user of the electronic device. The received marked data stored as marked data in response to marking the received information. The stored marked data is retrieved using the electronic device. The stored marked data is obtained and presented.

According to another aspect of the present application, the received markable data corresponds to a media item also received at the electronic device.

According to still another aspect of the present disclosure, wherein the media item is a broadcast program received at the electronic device.

According to yet another aspect of the present disclosure, the media item is a commercial presented in a broadcast program received at the electronic device.

According to another aspect of the present application, the media item is received in a radio broadcast program.

According to still another aspect of the present disclosure, the media item is received in a satellite broadcast program.

According to yet another aspect of the present disclosure, the media item is received by the electronic device from a location described by the media item.

According to another aspect of the present application, the method includes grouping the stored marked data with other stored marked data.

According to still another aspect of the present disclosure, the method also includes obtaining, using the stored marked data, background information descriptive of a target of the stored marked data.

According to yet another aspect of the present disclosure, the background information is obtained via the internet from a remote source.

According to another aspect of the present application, an address of the remote source is obtained from the stored marked data.

According to still another aspect of the present disclosure, the background information includes a description of an item for sale.

According to yet another aspect of the present disclosure, other media items received at the electronic device do not have corresponding markable data.

According to another aspect of the present application, the method includes analyzing the received markable data to determine that the received markable data is markable.

According to still another aspect of the present disclosure, the received markable data includes an identification corresponding to the media item, and the electronic device searches the received markable data for the identification corresponding to the media item.

According to yet another aspect of the present disclosure, the method includes alerting the user that the received markable data is markable upon the electronic device determining that the received markable data is markable.

According to an aspect of the present application, a device for marking, storing and retrieving data for items of information includes a receiver that receives markable data. A tangible input is dedicated to selectively marking received markable data at the discretion of a user of the electronic device. A processor marks the received markable data when the tangible input receives input from the user of the electronic device. A memory stores the received markable data as marked data in response to marking the received information. A tangible output that obtains and presents the stored markable data.

According to still another aspect of the present disclosure, the device also includes an alert interface that alerts the user of the device that received markable data is markable.

According to yet another aspect of the present disclosure, the processor searches through the received markable data to determine whether the received markable data is markable.

According to another aspect of the present application, a non-transitory computer readable medium stores a computer program for marking, storing and retrieving data for items of information. The computer readable medium includes a receiving code segment that receives markable data at an electronic device. The computer readable medium also includes a marking code segment that marks the received markable data using an input of the electronic device dedicated to selectively marking received markable data at the discretion of a user of the electronic device. The computer readable medium further includes a storing code segment that stores the received markable data as marked data in response to marking the received information. Moreover, the computer readable medium includes a retrieving code segment that retrieves the stored marked data using the electronic device. The computer readable medium additionally includes an outputting code segment that obtains and presents the stored markable data.

While a computer-readable medium herein may be shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for marking, storing and retrieving data for items of information, comprising:
receiving markable data at an electronic device;
marking the received markable data using an input of the electronic device dedicated to selectively marking received markable data at the discretion of a user of the electronic device;
storing the received marked data as marked data in response to marking the received information;
retrieving the stored marked data using the electronic device, and
obtaining and presenting the stored marked data.

2. The method of claim 1,
wherein the received markable data corresponds to a media item also received at the electronic device.

3. The method of claim 2,
wherein the media item is a broadcast program received at the electronic device.

4. The method of claim 2,
wherein the media item is a commercial presented in a broadcast program received at the electronic device.

5. The method of claim 2,
wherein the media item is received in a radio broadcast program.

6. The method of claim 2,
wherein the media item is received in a satellite broadcast program.

7. The method of claim 2,
wherein the media item is received by the electronic device from a location described by the media item.

8. The method of claim 1, further comprising:
grouping the stored marked data with other stored marked data.

9. The method of claim 1, further comprising:
obtaining, using the stored marked data, background information descriptive of a target of the stored marked data.

10. The method of claim 9,
wherein the background information is obtained via the interne from a remote source.

11. The method of claim 10,
wherein an address of the remote source is obtained from the stored marked data.

12. The method of claim 11,
wherein the background information comprises a description of an item for sale.

13. The method of claim 2,
wherein other media items received at the electronic device do not have corresponding markable data.

14. The method of claim 2, further comprising:
analyzing the received markable data to determine that the received markable data is markable.

15. The method of claim 14,
wherein the received markable data comprises an identification corresponding to the media item, and
wherein the electronic device searches the received markable data for the identification corresponding to the media item.

16. The method of claim 14, further comprising:
alerting the user that the received markable data is markable upon the electronic device determining that the received markable data is markable.

17. A device for marking, storing and retrieving data for items of information, comprising:
a receiver that receives markable data;
a tangible input dedicated to selectively marking received markable data at the discretion of a user of the electronic device;
a processor that marks the received markable data when the tangible input receives input from the user of the electronic device;
a memory that stores the received markable data as marked data in response to marking the received information, and
a tangible output that obtains and presents the stored markable data.

18. The device of claim 17, further comprising:
an alert interface that alerts the user of the device that received markable data is markable.

19. The device of claim 17,
wherein the processor searches through the received markable data to determine whether the received markable data is markable.

20. A non-transitory computer readable medium storing a computer program for marking, storing and retrieving data for items of information, comprising:
a receiving code segment that receives markable data at an electronic device;
a marking code segment that marks the received markable data using an input of the electronic device dedicated to selectively marking received markable data at the discretion of a user of the electronic device;
a storing code segment that stores the received markable data as marked data in response to marking the received information, and
a retrieving code segment that retrieves the stored marked data using the electronic device, and
an outputting code segment that obtains and presents the stored markable data.
